(19) United States
(12) Patent Application Publication
(10) Pub. No.: US 2015/0331786 A1
(43) Pub. Date: Nov. 19, 2015

(54) PATH EXECUTION REDUCTION IN SOFTWARE PROGRAM VERIFICATION

(71) Applicant: FUJITSU LIMITED, Kawasaki-shi (JP)

(72) Inventor: Maarten WIGGERS, San Jose, CA (US)

(73) Assignee: FUJITSU LIMITED, Kawasaki-shi (JP)

(21) Appl. No.: 14/278,783

(22) Filed: May 15, 2014

(51) Int. Cl. G06F 11/36

(52) U.S. Cl. CPC G06F 11/3676; G06F 11/3608

(57) ABSTRACT

A method of software program verification including receiving at least a portion of a software program that may further include a function under analysis (FUA). The method includes creating an FUA path based at least partially on a path through one or more functions of the received portion of the software program. The method includes determining whether the FUA path generates new coverage for the FUA. In response to the FUA path generating new coverage, the method includes selecting an FUA path statement from the FUA path. The method includes determining whether an uncovered code fragment of the FUA is reachable from the selected FUA path statement based at least partially on a set of covered FUA code fragments. In response to the uncovered code fragment being reachable from the selected FUA path statement, the method includes adding the selected FUA path statement to a set of covered statements.

### FIELD

The embodiments discussed herein are related to path execution reduction in software program verification.

### BACKGROUND

As usage of electronic devices increases, so does the number of software programs run on these devices. Typically when a software program is developed, it is verified to help assure that the software program satisfies all of the predetermined requirements for the software program. Developing test cases to determine if a software program satisfies all predetermined requirements may be difficult and time consuming.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of software program verification includes receiving at least a portion of a software program. The received portion of the software program may include a function under analysis (FUA). The method may include creating an FUA path based at least partially on a path through one or more functions included in the received portion of the software program. The method may include determining whether the FUA path generates new coverage for the FUA. In response to the FUA path generating new coverage, the method may include selecting an FUA path statement from the FUA path. The method may include determining whether an uncovered code fragment of the FUA is reachable from the selected FUA path statement based at least partially on a set of covered FUA code fragments. In response to the uncovered code fragment being reachable from the selected FUA path statement, the method may include adding the selected FUA path statement to a set of covered statements.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example software program verification tool (verification tool);

FIG. 2 illustrates an example computing device that may be implemented as the verification tool of FIG. 1;

FIGS. 3A and 3B are flowcharts of an example method of software program verification;

FIG. 4 illustrates an example class that may be analyzed by the verification tool of FIG. 1;

FIG. 5 illustrates a symbolic driver that may be configured to symbolically execute the class of FIG. 4;

FIG. 6 illustrates a control flow graph of a function under analysis included in the class of FIG. 4; and

FIG. 7 illustrates a symbolic execution tree of the class of FIG. 4.

### DESCRIPTION OF EMBODIMENTS

Some embodiments described herein generally relate to software program verification. In some embodiments, a software program verification tool (verification tool) may be configured to analyze and verify software programs. For example, the verification tool may be configured to analyze a function under analysis (FUA) within one or more classes of a software program. The verification tool may create one or more FUA paths based at least partially on paths of the class. The verification tool may determine whether each of the FUA paths generates new coverage for the FUA. In response to one of the FUA paths generating new coverage, the verification tool may select an FUA path statement from the FUA path. The verification tool may determine whether an uncovered code fragment of the FUA is reachable from the selected FUA path statement based at least partially on a set of covered FUA code fragments. In response to the uncovered code fragment being reachable from the selected FUA path statement, the verification tool may add the selected FUA path statement to a set of covered statements. The set of covered statements and the set of covered FUA code fragments are used in subsequently analyzed paths of the class and subsequently analyzed FUA paths. For example, if the set of covered statements indicate that one or more of the subsequently analyzed paths are already covered, then the verification tool may not symbolically execute the subsequently analyzed path. Additionally or alternatively, if the set of covered FUA code fragments indicate that one or more of the subsequently analyzed FUA paths are already covered, then the verification tool may not perform any further analysis of the FUA path. This and other embodiments will be explained with reference to the accompanying drawings.

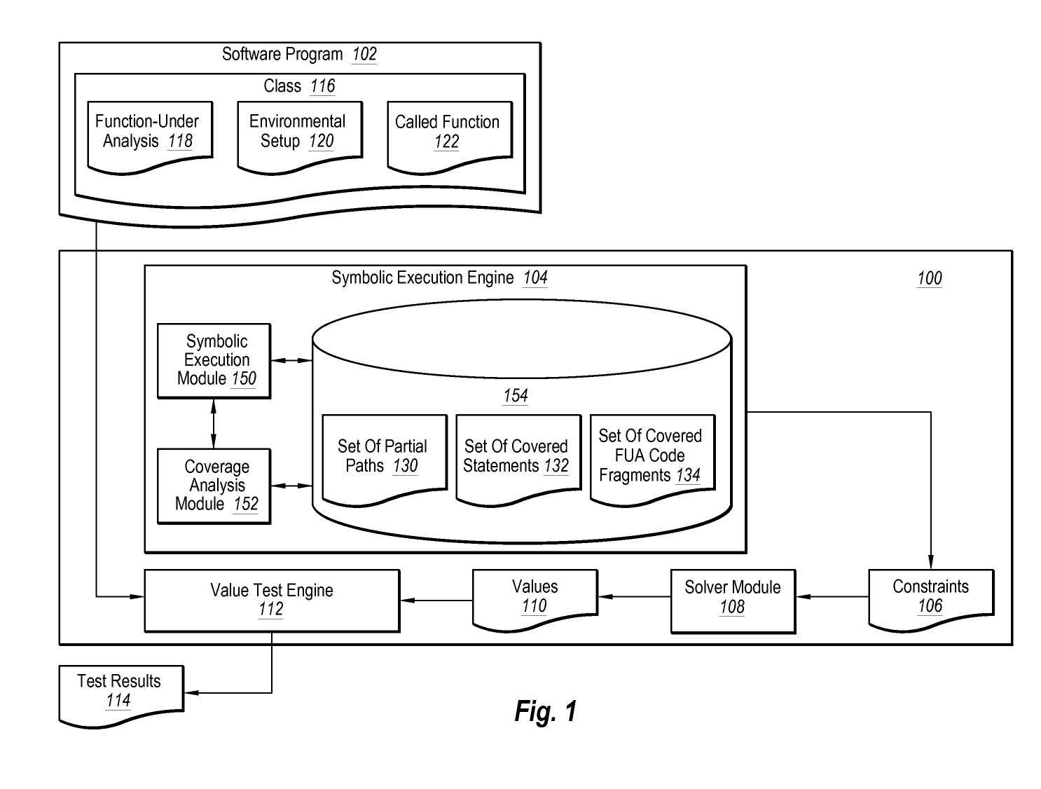

FIG. 1 illustrates a block diagram of an example software program verification tool (verification tool) 100. The verification tool 100 may be configured to verify and analyze a software program 102 and/or some portion thereof to identify defects therein. Generally, the verification tool 100 may be configured to perform a verification that includes an execution of one or more code fragments of the software program 102. The code fragments may be executed in sequences, which may be referred to as paths or partial paths. During the execution of the code fragments of the software program 102, the defects in the code fragments may be manifested and identified.

The verification tool 100 may include a symbolic execution engine 104. The symbolic execution engine 104 may be configured to symbolically execute the code fragments of the software program 102 or some portion thereof using symbolic variables. During the symbolic execution of the software program 102, the symbolic execution engine 104 may accumulate a set of constraints 106 for the symbolic variables. The set of constraints 106 may include expressions that dictate which path (e.g., which sequence of code fragments) is executed in the software program 102. For example, if a constraint of the set of constraints 106 is true, then the software program 102 may progress along a first path and if the constraint is false, then the software program 102 may progress along a second path.

The set of constraints 106 may be communicated to a solver module 108. The solver module 108 may then solve the set of constraints 106 for particular values 110. When the symbolic variables are equal to the particular values 110, the software program 102 progresses through the paths of the software program 102. The particular values 110 may be communicated to a value test engine 112. The value test engine 112 may execute the software program 102 or some portion thereof using the particular values 110. The value test engine 112 may output test results 114 indicating defects in the software program 102.

A metric involved in or utilized by the verification tool 100 may include coverage. Coverage may indicate a portion of a total number of code fragments of the software program 102 that is executed and/or analyzed during a verification process performed by the verification tool 100. A high coverage may indicate that the software program 102 or the portion thereof is thoroughly analyzed. A low coverage may indicate that the software program 102 or the portion thereof is not thoroughly analyzed. The verification tool 100 may be configured to maximize one or more types of coverage. The types of coverage may include, but are not limited to, statement coverage, branch coverage, decision coverage, condition coverage, state coverage, parameter value coverage, path coverage, modified condition/decision coverage (MCDC), and line coverage.

In addition to maximizing the coverage, the verification tool 100 may be configured to minimize a number of code fragments executed during the verification of the software program 102. By minimizing the number of code fragments executed during the analysis, the verification tool 100 may increase an efficiency with which the software program 102 is analyzed. Specifically, the verification tool 100 may be configured to reduce execution of code fragments that may be irrelevant and/or redundant.

For example, each and every code fragment may be symbolically executed. By executing each and every code fragment, the coverage may be high. However, the software verification may have executed the same code fragment multiple times or may have executed portions of the software program 102 that are ancillary to a specific set of code fragments of interest. In contrast, the verification tool 100 may reduce symbolic execution of irrelevant and/or redundant code fragments while maximizing coverage of relevant code fragments of the software program 102.

In particular, the software program 102 may include a class 116. The class 116 may include a function under analysis (FUA) 118, an environmental setup 120, and a called function 122. The FUA 118 may include a portion of the class 116 or the software program 102 that is of interest during the analysis performed by the verification tool 100. For example, the FUA 118 may be the portion of the class 116 or the software program 102 in which defects are being identified. The environmental setup 120 may include one or more constructors that assign values to variables in the class 116 or generally sets up context for the FUA 118. The called function 122 may include a member function that is called or otherwise included in the FUA 118.

The symbolic execution engine 104 may be configured to symbolically execute the FUA 118 and to maximize coverage of the FUA 118. Additionally, the symbolic execution engine 104 may be configured to reduce execution of redundant code fragments included in the FUA 118 and reduce execution of code fragments included in the environmental setup 120 and/or the called function 122.

The symbolic execution engine 104 may include a symbolic execution module 150 and a coverage analysis module 152. The symbolic execution module 150 may be configured to perform symbolic execution of the class 116 in conjunction with a coverage analysis that may be performed by the coverage analysis module 152. The symbolic execution module 150 and the coverage analysis module 152 may be configured to determine whether each extension of a partially explored path of the class 116 improves coverage of the FUA 118. In response to the extension of the partially explored paths of the class not improving coverage of the FUA 118, symbolic execution of the partially explored path of the class 116 may be stopped. Accordingly, paths of the class 116 that do not improve the coverage of the FUA 118 may not be completely symbolically executed.

In some embodiments, the symbolic execution module 150 and the coverage analysis module 152 may receive the FUA 118 within the software program 102 or, in particular in some embodiments, within the class 116. The symbolic execution module 150 and the coverage analysis module 152 may combine to symbolically execute a subset of paths included in the class 116. The subset of paths may include the statements and code fragments that increase coverage of the FUA 118 and may omit redundant or irrelevant code fragments.

For example, the coverage analysis module 152 may create an FUA path. The FUA path may include a sequence of code fragments of the FUA 118. One or more partially explored paths of the class 116 may map to a single FUA path. The creation of the FUA path may be based at least partially on a path or partial path of the class 116 and/or a statement of the selected path or selected partial paths discussed below.

The coverage analysis module 152 may determine whether the FUA path generates new coverage for the FUA 118. For example, the coverage analysis module 152 may determine that the FUA path includes a non-redundant and/or a relevant sequence of code fragments included in the FUA 118. In response to the FUA path not generating new coverage, the coverage analysis module 152 may update a set of partial paths 130 included in the class 116. Updating the set of partial paths 130 may include removing the path or partial path used to create the FUA path or otherwise indicating that the path or partial path has been explored. The set of partial paths 130 may be included in a database 154, which may be included in the symbolic execution engine 104 or another accessible module or engine.

In response to the FUA path generating new coverage for the FUA 118, the coverage analysis module 152 may assess one or more statements in the FUA path. For example, the coverage analysis module 152 may select a first statement from the FUA path. The coverage analysis module 152 may determine whether an uncovered FUA code fragment of the FUA 118 is reachable from the first selected statement. The determination may be based on the FUA 118 and/or a set of covered FUA code fragments 134, for example. In response to an uncovered FUA code fragment being reachable from the first selected statement, the coverage analysis module 152 may add the first selected statement to a set of covered statements 132. In response to an uncovered FUA code fragment not being reachable from the first selected FUA path statement, the coverage analysis module 152 may move onto a next FUA path statement in the FUA path. The coverage analysis module 152 may continue the assessment for each FUA path statement in the FUA path.

After each of the FUA path statements has been assessed, the coverage analysis module 152 may update the set of covered FUA code fragments 134. For example, the coverage analysis module 152 may indicate which FUA code fragments the FUA path covers. The coverage analysis module 152 may then determine whether the FUA 118 is completely covered. For example, if each of the FUA code fragments is covered by the FUA path or a combination of FUA paths, the coverage analysis module 152 may determine the FUA is completely covered. In response to the FUA 118 being completely covered, the coverage analysis module 152 may stop symbolic execution of the FUA 118 and the class 116. In response to the FUA 118 not being completely covered, the coverage analysis module 152 may update the set of partial paths 130. For example, updating the set of partial paths 130 may include removing the path or partial path used to create the FUA path from the set of partial paths 130 and/or otherwise indicating that the path or partial path is fully explored. By updating the set of partial paths 130, the path or partial path used to create the FUA path may not be subsequently analyzed and/or symbolically executed.

Additionally, the symbolic execution module 150 may determine whether there is a resource constraint or there are no more unexplored paths or partial paths in the class 116. The resource constraint may include a limitation to computational space or processing capacity, for example. A determination that there are no more unexplored paths or partial paths may be based on the set of partial paths 130. For example, if the set of partial paths 130 include no more partially explored paths, it may be determined that there are no more unexplored paths or partial paths. In response to there being a resource constraint or there being no more partially explored paths, the symbolic execution module 150 may stop a symbolic execution of the FUA 118 and the class 116.

In response to there not being a resource constraint or there being more unexplored paths, the symbolic execution module 150 may select a path or partial path of the class 116. The symbolic execution module 150 may select a path statement included in the selected path. The symbolic execution module 150 may determine whether the selected path statement is covered based at least partially on the set of covered statements 132. In response to the selected path statement not being covered, the symbolic execution module 150 may symbolically execute the selected path statement. In response to the selected path statement being covered, the symbolical execution module 150 may not symbolically execute the selected path statement. Additionally or alternatively, the selected path and/or the selected path statement may be used to create another FUA path. The symbolic execution module 150 may communicate the other FUA path to the coverage analysis module 152. The coverage analysis module 152 may assess the FUA path statements for coverage of the FUA 118 as discussed herein.

The above process may continue until one or more stopping conditions exist. The stopping conditions may include one or more of the FUA 118 is fully covered, there are no more unexplored or partially explored paths in the class 116 as indicated by the set of partial paths 130, and presence or existence of a resource constraint.

Thus, the symbolic execution engine 104 may reduce a number of paths and/or partial paths of the class 116 that are symbolically executed. Specifically in this and other embodiments, in response to an FUA path not increasing the coverage of the FUA 118, the path or partial path used to create the FUA path may be removed from or indicated as explored in the set of partial paths 130. Additionally, the set of covered FUA code fragments 134 is used to determine whether an FUA path provides new coverage of the FUA 118. Accordingly, there may not be symbolic execution of partially covered paths that map to already-covered FUA paths or already-covered FUA code fragments. Additionally, the determination of whether a path statement of a selected path is covered may be based on the set of covered statements 132. Accordingly, previously covered path statements may not be symbolically executed.

Modifications, additions, or omissions may be made to the verification tool 100 without departing from the scope of the present disclosure. Specifically, embodiments depicted in FIG. 1 include one software program 102 having one class 116, one FUA 118, one environmental setup 120, and one called function 122. However, the present disclosure may be applied to one or more software programs 102, one or more of which may include one or more classes 116, one or more FUAs 118, one or more environmental setups 120, one or more called functions 122, or any combination thereof.

Moreover, the separation of various components in the embodiments described herein is not meant to indicate that the separation occurs in all embodiments. Additionally, it may be understood with the benefit of this disclosure that the described components may be integrated together in a single component or separated into multiple components.

The symbolic execution engine 104, the symbolic execution module 150, the coverage analysis module 152, the value test engine 112, and the solver module 108 may include code and routines for software program verification. In some embodiments, one or more of the symbolic execution engine 104, the symbolic execution module 150, the coverage analysis module 152, the value test engine 112, and the solver module 108 may be stored on one or more computing devices, for instance. In some embodiments, the verification tool 100 or any component thereof that may be implemented using hardware including a field-programmable gate array (FPGA) or an application-specific integrated circuit (ASIC). In some other instances, the verification tool 100 or any component thereof may be implemented using a combination of hardware and software.

The verification tool 100 and/or any component (e.g., 104, 150, 152, 154, 112, and 108) thereof may be stored in memory or other non-transitory computer medium that stores data and/or computer instructions for providing the functionality described herein. The memory may be included in storage that may include a dynamic random access memory (DRAM) device, a static random access memory (SRAM) device, flash memory, or some other memory devices. In some embodiments, the storage also includes a non-volatile memory or similar permanent storage device such as a hard disk drive, a floppy disk drive, a CD-ROM device, a DVD-ROM device, a DVD-RAM device, a DVD-RW device, a flash memory device, or some other mass storage device for storing information on a more permanent basis.

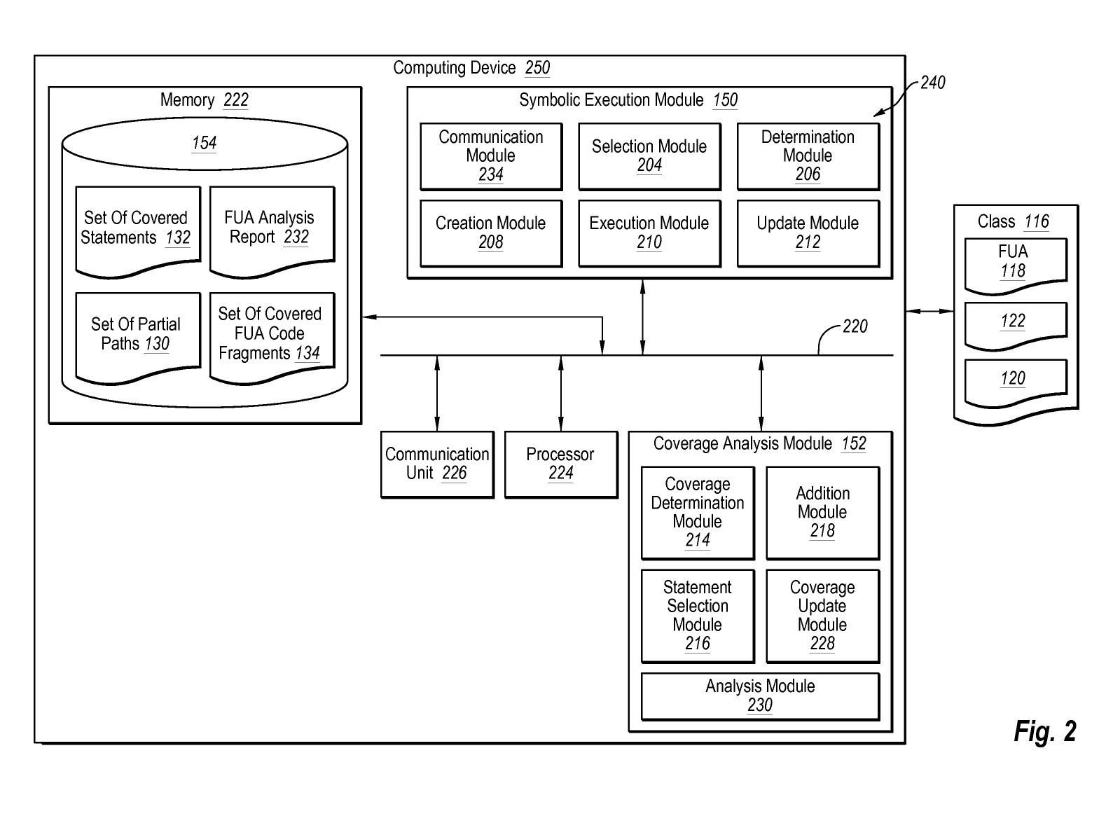

Referring now to FIG. 2, examples of the symbolic execution module 150 and the coverage analysis module 152 are shown in more detail. FIG. 2 is a block diagram of a computing device 250 that includes the symbolic execution module 150, the coverage analysis module 152, a processor 224, a memory 222, and a communication unit 226. The components of the computing device 250 may be communicatively coupled by a bus 220. In some embodiments, the computing device 250 may include a hardware server or hardware device that includes the verification tool 100 of FIG. 1.

With combined reference to FIGS. 1 and 2, the processor 224 may include an arithmetic logic unit (ALU), a microprocessor, a general-purpose controller, or some other processor array to perform computations and software program analysis. The processor 224 may be coupled to the bus 220 for communication with the other components (e.g., 150, 152, 226, and 222). The processor 224 generally processes data signals and may include various computing architectures including a complex instruction set computer (CISC) architecture, a reduced instruction set computer (RISC) architecture, or an architecture implementing a combination of instruction sets. Although FIG. 2 includes a single processor 224, multiple processors may be included in the computing device 250. Other processors, operating systems, and physical configurations may be possible.

The memory 222 may be configured to store instructions and/or data that may be executed and/or manipulated by the processor 224. The memory 222 may be coupled to the bus 220 for communication with the other components. The instructions and/or data may include code for performing the techniques or methods described herein. The memory 222 may include a DRAM device, an SRAM device, flash memory, or some other memory device. In some embodiments, the computing device 250 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In the depicted embodiment, the memory 222 includes the database 154. The database 154 may be configured to store and/or enable access to the set of covered statements 132, the set of partial paths 130, the set of covered FUA code fragments 134, and an FUA analysis report 232. For example, the coverage analysis module 152 and the symbolic execution module 150 may access one or more of the set of covered statements 132, the set of partial paths 130, the set of covered FUA code fragments 134, and the FUA analysis report 232 via the bus 220. The coverage analysis module 152 and the symbolic execution module 150 may update the contents of the set of covered statements 132, the set of partial paths 130, the set of covered FUA code fragments 134, and the FUA analysis report 232. For example, the coverage analysis module 152 and the symbolic execution module 150 may remove or add a path statement from the set of covered statements 132 or otherwise indicate that the path statement is covered in the set of covered statements 132. The coverage analysis module 152 and the symbolic execution module 150 may subsequently access the set of covered statements 132 to determine whether a particular path statement is included in the set of covered statements 132 or indicated as covered in the set of covered statements 132.

In some embodiments, the database 154 or some portion thereof such as the set of covered statements 132, the set of partial paths 130, the FUA analysis report 232, the set of covered FUA code fragments 134, some portions thereof, or some combinations thereof may be located remotely from the computing device 250. The database 154 or the portion thereof located remotely may be accessed by the computing device 250 or modules (e.g., the coverage analysis module 152 and the symbolic execution module 150) included therein.

The communication unit 226 may be configured to transmit and receive data to and from another system or server. The communication unit 226 may be coupled to the bus 220. In some embodiments, the communication unit 226 includes a port for direct physical connection to a communication network or to another communication channel. For example, the communication unit 226 may include a USB, SD, CAT-5, or similar port for wired communication. In some embodiments, the communication unit 226 includes a wireless transceiver for exchanging data via communication channels using one or more wireless communication methods, including IEEE 802.11, IEEE 802.16, BLUETOOTH®, or another suitable wireless communication method.

In some embodiments, the communication unit 226 includes a wired port and/or a wireless transceiver. The communication unit 226 may also provide other conventional connections for distribution of files and/or other data using standard network protocols including transmission control protocol/internet protocol (TCP/IP), HTTP, HTTP secure (HTTPS), and simple mail transfer protocol (SMTP). Alternately or additionally, the communication unit 226 may include a cellular communications transceiver for sending and receiving data over a cellular communications network including via short message service (SMS), multimedia messaging service (MMS), hypertext transfer protocol (HTTP), direct data connection, wireless application protocol (WAP), e-mail, or another suitable type of electronic communication.

In the embodiment of FIG. 2, the symbolic execution module 150 may include a communication module 234, a selection module 204, a determination module 206, a creation module 208, an execution module 210, and an update module 212. The coverage analysis module 152 may include a coverage determination module 214, a statement selection module 216, an addition module 218, a coverage update module 228, and an analysis module 230. The communication module 234, the selection module 204, the determination module 206, the creation module 208, the execution module 210, the update module 212, the coverage determination module 214, the statement selection module 216, the addition module 218, the coverage update module 228, and the analysis module 230 are collectively, referred to as modules 240.

Each of the modules 240 may be implemented as software including one or more routines configured to perform one or more operations. The modules 240 may include a set of instructions executable by the processor 224 to provide the functionality described below. In some instances, the modules 240 may be stored in or at least temporarily loaded into the memory 222 of the computing device 250 and may be accessible and executable by the processor 224. One or more of the modules 240 may be adapted for cooperation and communication with the processor 224 and components of the computing device 250 via the bus 220.

The communication module 234 may be configured to handle communications between the symbolic execution module 150 and/or the coverage analysis module 152 and other components of the computing device 250 (e.g., 224, 222, and 226). The communication module 234 may be configured to send and receive data, via the communication unit 226 to outside systems. In some instances, the communication module 234 may cooperate with the other modules (e.g., 204, 206, 208, 210, 212, 214, 216, 218, 228, and 230) to receive and/or forward, via the communication unit 226, data from the components. For example, the communication module 234 of the symbolic execution module 150 may be configured to receive a portion of the software program 102. The received portion of the software program 102 may include the class 116. The class 116 may include the FUA 118, the environmental setup 120, and the called function 122. The communication module 234 may be configured to communicate the paths and the partial paths included in the class 116 to the coverage analysis module 152 and the database 154. Additionally, the communication module 234 may be configured to communicate the class 116 and the FUA 118 to the coverage analysis module 152. In these and other embodiments, the FUA 118, the environmental setup 120, and the called function 122 may be accessible by the coverage analysis module 152 and/or the symbolic execution module 150.

The selection module 204 may be configured to select a path or partial path of the class 116. The selection module 204 may be configured to select the path or the partial path from the set of partial paths 130. For example, paths or partial paths that are removed from the set of partial paths 130 may not be selected. Additionally or alternatively, paths or partial paths indicated as explored in the set of partial paths 130 may not be selected. Accordingly, the path or the partial path that is selected may be one of the paths or partial paths that have not been symbolically executed or otherwise indicated as explored from the set of partial paths 130. The selection module 204 may then select a path statement from the selected path or partial path. The selected path statement may be communicated to the determination module 206.

The determination module 206 may be configured to make determinations regarding coverage, a presence of resource constraints, and a presence of paths or partial paths in the set of partial paths 130. The determination module 206 may receive the selected path statement from the selection module 204. The determination module 206 may then determine whether the selected path statement is covered. In some embodiments, the determination module 206 may base the determination at least partially on the set of covered statements 132. For example, another path statement may be included in the set of covered statements 132 that also covers the selected path statement. The determination module 206 may access the set of covered statements 132 and may read data indicating that the selected path statement is covered or not covered. In response to the selected path statement not being covered, the determination module 206 may communicate a signal indicating the selected path statement is not covered to the execution module 210. In response to the selected path statement being covered, the determination module 206 may communicate a signal indicating the selected path statement is covered to the creation module 208.

The execution module 210 may be configured to symbolically execute the selected path statement. The execution module 210 may then communicate a signal indicating completion of the symbolic execution to the update module 212. The update module 212 may then update the set of partial paths 130. For example, the update module 212 may remove the selected path statement from the paths or partial paths included in the set of partial paths 130. Additionally or alternatively, the update module 212 may update the set of partial paths 130 to indicate that the selected path statement has been executed and/or explored.

The determination module 206 may then determine whether there are paths or partial paths remaining in the set of partial paths 130 that have not been executed, removed, or otherwise indicated as explored. Additionally, the determination module 206 may determine whether a resource constraint exists. In response to a determination that there are no remaining paths or partial paths in the set of partial paths 130 or a determination that there is a resource constraint, the symbolic execution module 150 may stop symbolic execution of the FUA 118 and the class 116. In response to a determination that there are remaining paths or partial paths in the set of partial paths 130 or a determination that there is not a resource constraint, the determination module 206 may communicate a signal to the selection module 204 indicating remaining paths or partial paths in the set of partial paths 130 and/or that no resource constraint exists. In response, the selection module 204 may select another path or partial path of the set of partial paths 130. The selection module 204 may communicate the path or partial path to the creation module 208. Additionally or alternatively, the selection module 204 may select another selected path statement. One or more of the operations above may be repeated as described herein.

The creation module 208 may receive the path or partial path from the selection module 204 and/or the selected path statement from the determination module 206. The creation module 208 may be configured to create an FUA path from the path, the partial path, the selected path statement, or some combination thereof. Additionally or alternatively, the creation module 208 may create the FUA path from the FUA 118. The creation module 208 may communicate the FUA path to the coverage determination module 214 of the coverage analysis module 152.

The coverage determination module 214 may be configured to determine whether the FUA path generates new coverage for the FUA 118. In some embodiments, the coverage determination module 214 may determine whether the FUA path generates new coverage for the FUA 118 based at least partially on the set of covered FUA code fragments 134. The set of covered FUA code fragments 134 may include one or more covered FUA code fragments, which may have been determined in analysis of other FUA paths. The coverage determination module 214 may compare the covered FUA code fragments with the code fragments included in the FUA path. If execution of the code fragments in the FUA path leads to coverage of the FUA code fragments in the set of covered FUA code fragments 134, then the coverage determination module 214 may determine that the FUA path does not generate new coverage for the FUA 118.

In response to the FUA path not generating new coverage of the FUA 118, the coverage determination module 214 may communicate a signal indicating the FUA path does not generate new coverage to the update module 212. The update module 212 may update the set of partial paths 130. For example, the update module 212 may indicate that the selected path or selected path statement used to create the FUA path is explored. After, the determination module 206 may determine whether there are paths or partial paths remaining in the set of partial paths 130 or if a resource constraint exists. The symbolic execution module 150 may stop symbolic execution of the FUA 118 and/or the class 116 if no paths or partial paths remain in the set of partial paths or a resource constraint exists. The selection module 204 may select another path or another partial path remaining in the set of partial paths 130 in response to a signal communicated from the determination module 206 indicating that there are paths or partial paths remaining in the set of partial paths 130 and/or no resource constraint exists. The selection module 204 may additionally select another path statement and one or more operations may be repeated for the selected remaining path and/or the selected path statement as discussed herein.

In response to the FUA path generating new coverage, the coverage determination module 214 may communicate a signal to the statement selection module 216 and to the analysis module 230. The analysis module 230 may be configured to conduct a symbolic analysis of the FUA path. For example, the symbolic analysis may perform a forward reachability analysis along the FUA path and mark statements of the FUA path. The analysis module 230 may then communicate results of the symbolic analysis to the FUA analysis report 232.

The statement selection module 216 may be configured to select an FUA path statement from the FUA path. The statement selection module 216 may communicate the selected FUA path statement to the coverage determination module 214. The coverage determination module 214 may determine whether an uncovered code fragment of the FUA 118 is reachable from the selected FUA path statement. The coverage determination module 214 may base the determination at least partially on the set of covered FUA code fragments 134 and/or the FUA 118.

In response to an uncovered code fragment being reachable from the selected FUA path statement, the coverage determination module 214 may communicate a signal indicating an uncovered code fragment is reachable from the selected FUA path statement to the addition module 218. The addition module 218 may be configured to add the selected FUA path statement to the set of covered statements 132.

After the addition module 218 adds the selected FUA path statement to the set of covered statements 132 or in response to an uncovered code fragment not being reachable from the selected FUA path, the coverage determination module 214 may determine whether the FUA path includes one or more additional FUA path statements. In response to a determination that one or more additional FUA paths are included in the FUA, the statement selection module 216 may select each of the additional FUA path statements in turn, the coverage determination module 214 may then determine if an uncovered code fragment is reachable from the selected FUA path statements, and the addition module 218 may add the selected FUA path statement to the set of covered statements 132 in response to the conditions discussed above.

In response to the coverage determination module 214 determining that no additional FUA path statements are included in the FUA statement, the coverage determination module 214 may determine whether the FUA 118 is covered. In response to the FUA 118 being fully covered, the coverage analysis module 152 may be configured to stop symbolic execution of the FUA 118 and/or the class 116. In response to the FUA 118 not being fully covered, the coverage determination module 214 may communicate a signal to the update module 212. The update module 212 may update the set of partial paths 130. The determination module 206 may determine whether there are paths or partial paths remaining in the set of partial paths 130 or if a resource constraint exists. The symbolic execution module 150 may stop symbolic execution of the FUA 118 and/or the class 116. The selection module 204 may select another path or another partial path remaining in the set of partial paths 130. The selection module 204 may additionally select another path statement, and one or more operations may be repeated for the selected remaining path and/or the selected path statement as discussed herein.

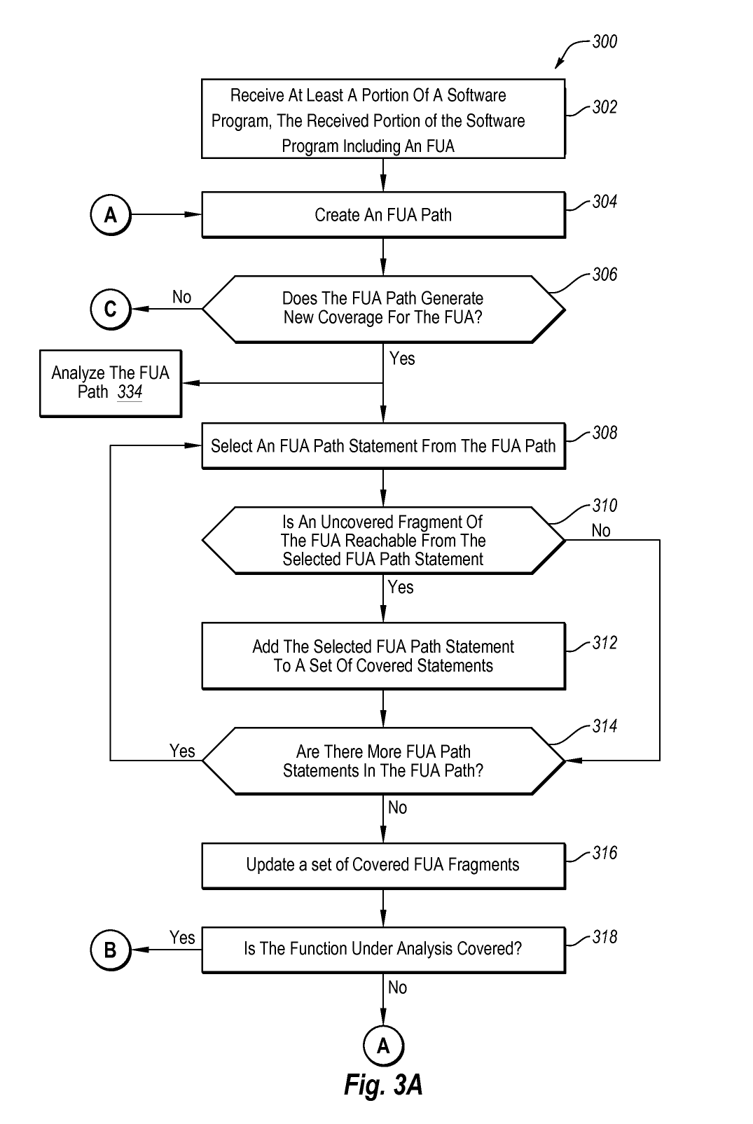

FIGS. 3A and 3B are flowcharts of an example method 300 of software program analysis, arranged in accordance with at least one embodiment described herein. The method 300 may be programmably performed in some embodiments by the computing device 250 described with reference to FIG. 2. Additionally or alternatively, the method 300 may be programmably performed by a verification tool such as the verification tool 100 of FIG. 1. The verification tool 100 and/or the computing device 250 may include or may be communicatively coupled to a non-transitory computer-readable medium (e.g., the memory 222 of FIG. 2) having stored thereon or encoded therein programming code or instructions that are executable by a processor to perform or cause performance of the method 300. The verification tool 100 and/or the computing device 250 may include a processor (e.g., the processor 224 of FIG. 2) that is configured to execute computer instructions to cause or control performance of the method 300. Although illustrated as discrete blocks, various blocks may be divided into additional blocks, combined into fewer blocks, or eliminated, depending on the desired implementation.

With reference to FIG. 3A, the method 300 may begin at block 302, where at least a portion of a software program is received. The received portion of the software program may include an FUA. For example, with reference to FIG. 1, a portion of the software program 102 may include the class 116, which may further include the FUA 118. The portion of the software program 102 may be received by the verification tool 100.

At block 304, an FUA path may be created. In some embodiments, the FUA path may be created based at least partially from a selected partial path and/or a selected path of the received portion of the software program. For example, with reference to FIG. 2, the creation module 208 may create the FUA path from a partial path and/or a path selected by the selection module 204 from the set of partial paths 130 of the class 116.

At block 306, it may be determined whether the FUA path generates new coverage for the FUA. In some embodiments, the determination may be based on a set of covered FUA code fragments. For example, with reference to FIG. 2, the coverage determination module 214 may determine whether the FUA path generates new coverage based on the set of covered FUA code fragments 134. In response to a determination that the FUA path generates new coverage (“Yes” at block 306), the method may proceed to blocks 308 and/or 334. In response to a determination that the FUA path does not generate new coverage (“No” at block 306), the method 300 may proceed to block 320.

At block 308, an FUA path statement may be selected from the FUA path. For example, with reference to FIG. 1, the statement selection module 216 may select an FUA path statement from the FUA path. At block 334, the FUA path may be analyzed. For example, with reference to FIG. 2, the analysis module 230 may analyze the FUA path and generate the FUA analysis report 232.

At block 310, it may be determined whether an uncovered fragment of the FUA is reachable from the selected FUA path statement. In some embodiments, the determination may be based on a set of covered FUA code fragments. For example, with reference to FIG. 2, the coverage determination module 214 may determine whether an uncovered fragment of the FUA is reachable from the selected FUA path statement based on the set of covered FUA code fragments 134. In response to a determination that an uncovered fragment of the FUA is reachable from the selected FUA path statement (“Yes” at block 310), the method 300 may proceed to block 312. In response to a determination that an uncovered fragment of the FUA is not reachable from the selected FUA path statement (“No” at block 310), the method 300 may proceed to block 314.

At block 312, the selected FUA path statement may be added to a set of covered statements. For example, with reference to FIG. 2, the addition module 218 may add the selected FUA path statement to the set of covered statements 132.

At block 314, it may be determined whether there are more FUA path statements included in the FUA path. In response to a determination that there are more FUA path statements included in the FUA path (“Yes” at block 314), the method 300 may proceed through one or more of blocks 308, 310, 312, and 314. In response to a determination that there are not more FUA path statements included in the FUA path (“No” at block 314), the method 300 may proceed to block 316.

At block 316, a set of covered FUA fragments may be updated. For example, with reference to FIG. 2, the coverage update module 228 may update the set of covered FUA code fragments 134.

At block 318, it may be determined whether the FUA is covered. For example, with reference to FIG. 2, the coverage determination module 214 may determine whether the FUA 118 is covered. In response to a determination that the FUA is covered (“Yes” at block 318), the method 300 may proceed to block 332 of FIG. 3B. At block 332, the method 300 may stop. In response to a determination that the FUA is not covered (“No” at block 310), the method 300 may proceed to block 320 of FIG. 3B.

Referring to FIG. 3B, at block 320, a set of partial paths may be updated. For example, with reference to FIG. 2, the update module 212 may update the set of partial paths 130. At block 322, it may be determined whether a resource constraint exists or if there are no more partial paths. In response to a determination that there exists a resource constraint or there are no more partial paths (“Yes” at block 322), the method 300 may proceed to block 332 where the method 300 may stop. In response to a determination that there is not a resource constraint or there are more partial paths (“No” at block 322), the method 300 may proceed to block 324.

At block 324, a path may be selected from the set of partial paths. In some embodiments, a partial path may be selected from the set of partial paths. For example, with reference to FIG. 2, the selection module 204 may select a path or a partial path from the set of partial paths 130. Following block 324, the method 300 may then proceed to one or more of blocks 304, 306, 308, 310, 312, 314, 316, 318, 320, and 332.

Additionally or alternatively, the method 300 may proceed to block 326 following block 324. At block 326, a path statement may be selected. For example, with reference to FIG. 2, the selection module 204 may select a path statement from the selected path or selected partial path.

At block 328, it may be determined whether the selected path statement is covered. In some embodiments, the determination may be based on a set of fully covered statements. For example, with reference to FIG. 2, the determination module 206 may determine whether the selected path statement is covered based at least partially on the set of covered statements 132. In response to a determination that the selected path statement is covered (“Yes” at block 328), the method 300 may proceed to one or more of blocks 304, 306, 308, 310, 312, 314, 316, 318, 320, 322, and 332. In response to a determination that the selected path statement is not covered (“No” at block 328), the method 300 may proceed to block 330.

At block 330, the selected path statement may be executed. For example, with reference to FIG. 2, the selected path statement may be symbolically executed by the execution module 210. Following block 330, the method 300 may proceed to one or more of blocks 304, 306, 308, 310, 312, 314, 316, 318, 320, 322, 328, and 332.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

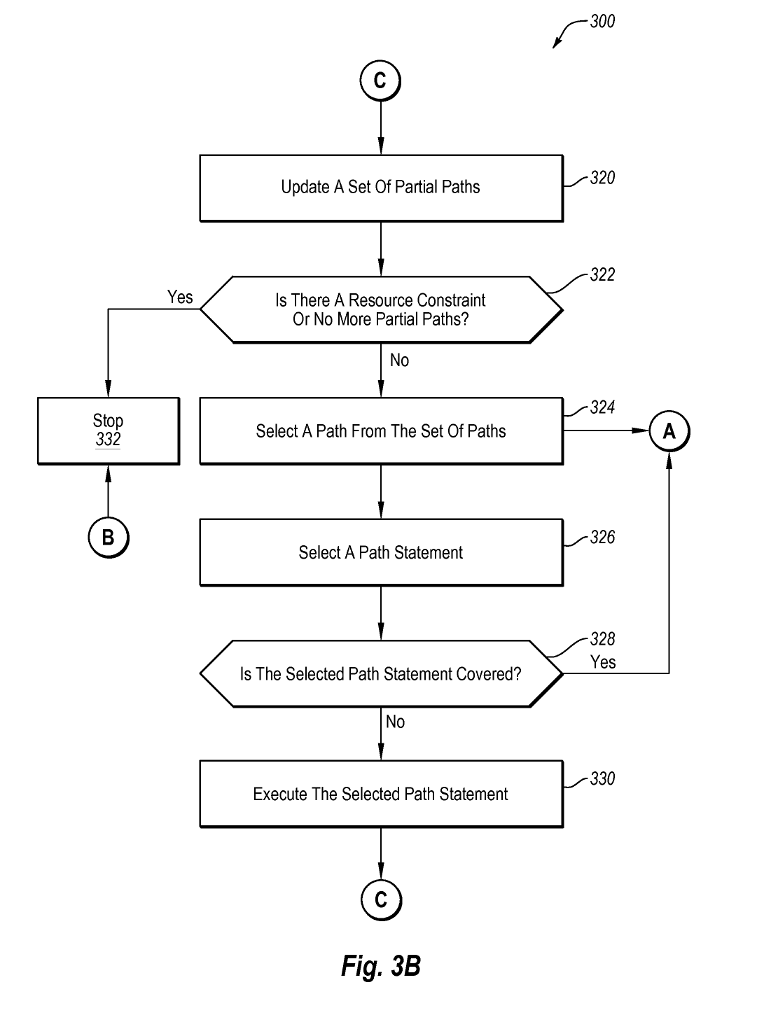

FIGS. 4-7 present an example software analysis according to some embodiments discussed herein. FIG. 4 depicts an example of the class 116 that may be analyzed by the verification tool 100 of FIG. 1 or the computing device 250 of FIG. 2. The class 116 includes an example of the FUA 118, an example of the environmental setup 120, and an example of the called function 122. In the class 116, the FUA 118, the environmental setup 120, and the called function 122 are written in pseudo code in a C/C++style. Embodiments disclosed herein are not limited to analysis or verification of programs written in C/C++. In some embodiments, the verification tool 100 and/or the computing device 250 of FIG. 2 may be configured to analyze software programs written in programming languages including, but not limited to, C, C++, JavaScript, Java, Python, PHP, FBML, ASP.NET, J2EE, and any other suitable programming languages.

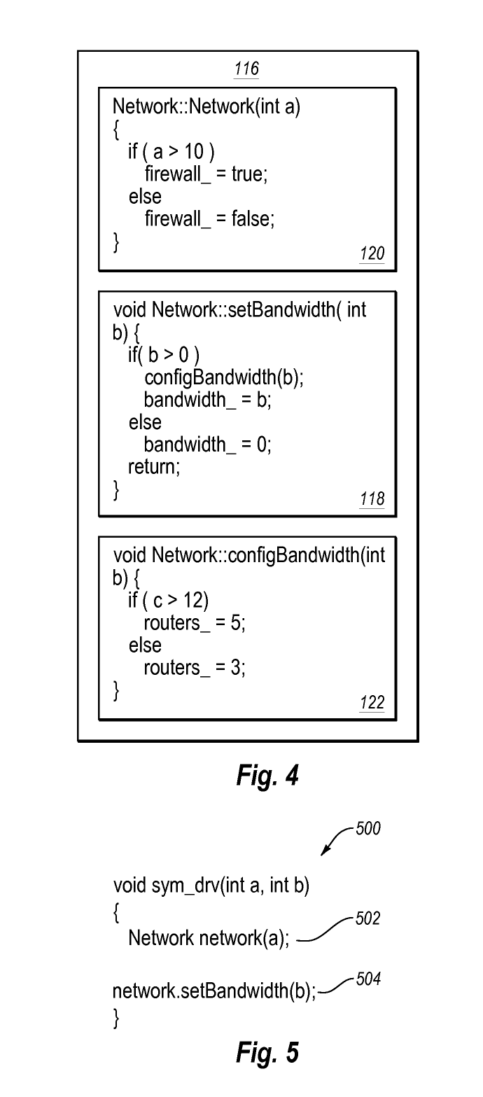

FIG. 5 illustrates a symbolic driver 500. The symbolic driver 500 may be configured to symbolically execute the class 116 of FIG. 4. Specifically, the symbolic driver 500 may include a code fragment 502 that executes the environmental setup 120 and another code fragment 504 that executes the FUA 118. By executing the FUA 118, the called function 122 may also be executed. In some embodiments, the symbolic driver 500 may be implemented in an execution module such as the execution module 210 of FIG. 2.

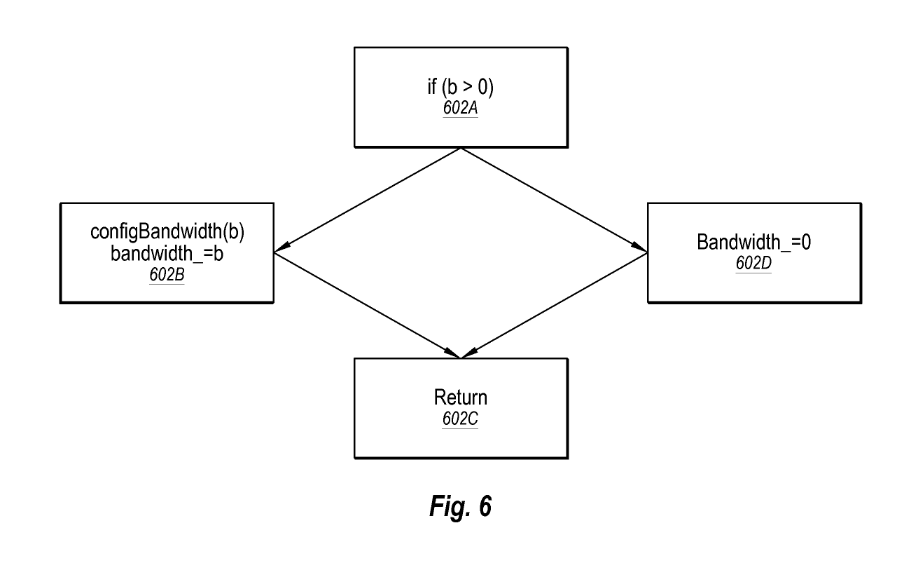

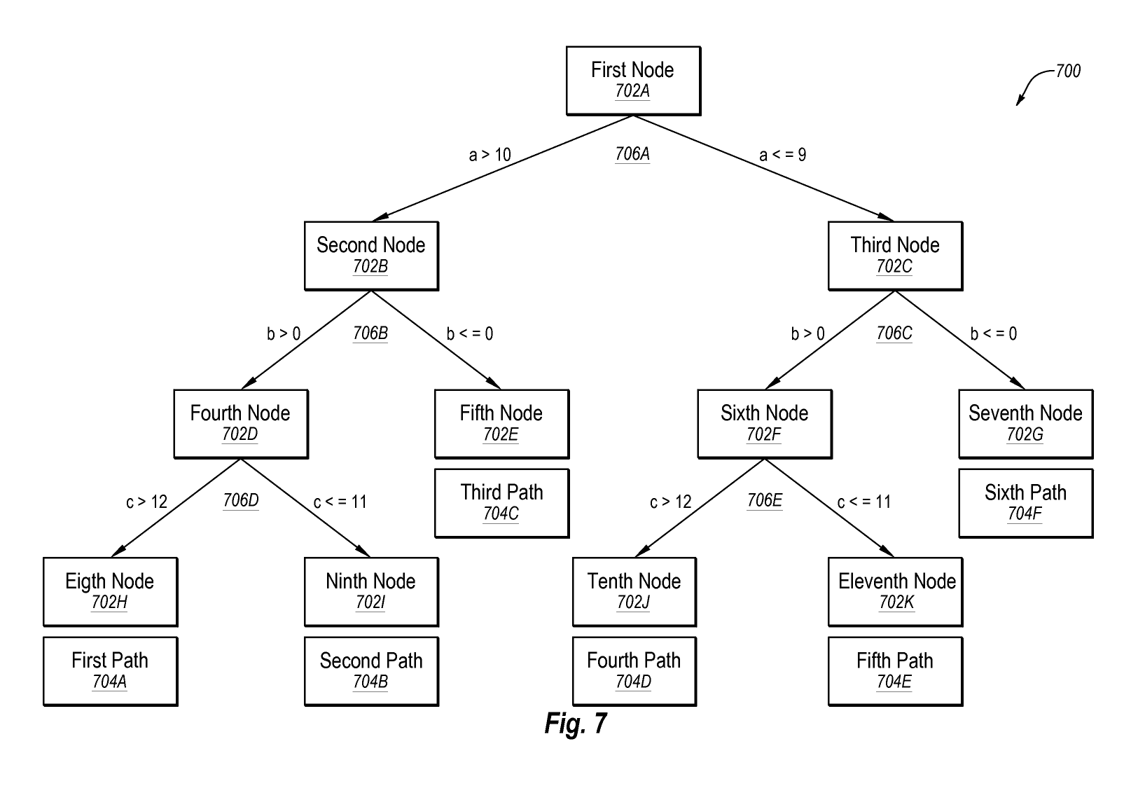

FIG. 6 illustrates a control flow graph 600 of the FUA 118 of FIG. 4. The control flow graph 600 includes basic blocks 602A-602D. A first basic block 602A corresponds to the “if” statement in the FUA 118. A second basic block 602B corresponds to the “configBandwidth (b)” and “bandwidth_=b” code fragments in the FUA 118. A third basic block 602C corresponds to the “return” code fragment of the FUA 118. A fourth basic block 602D corresponds to the “else bandwidth_{—}=0” code fragment. The basic blocks 602A-602D illustrate that the FUA 118 may only include two paths for branch coverage. The control flow graph 600 may further illustrate coverage of the FUA 118 during the analysis discussed with reference to FIG. 7.

FIG. 7 illustrates a symbolic execution tree (tree) 700 of the class 116. The tree 700 includes nodes 702A-702K (generally, node 702 or nodes 702), paths 704A-704F (generally, path 704 or paths 704), and branches 706A-706E (generally, branch 706 or branches 706). The paths 704 represent sequences of nodes 702. For example, a first path 704A represents a sequence of a first node 702A, a second node 702B, a fourth node 702D, and an eighth node 702H. Likewise, a second path 704B represents a sequence of the first node 702A, the second node 702B, the fourth node 702D, and a ninth node 7021. The branches 706 represent decision points between sequences of nodes 702. For example, a first branch 706A represents a decision point between a sequence from the first node 702A to the second node 702B or from the first node 702A to a third node 702C.

In the tree 700, the first branch 706A, the first node 702A, the second node 702B, and the third node 702C represent the environmental setup 120. Specifically, the first branch 706A from the first node 702A to the second node 702B or from the first node 702A to the third node 702C may be based on a value of a first variable “a.” When “a” is greater than 10 then a sequence in the tree 700 is from the first node 702A to the second node 702B and when “a” is smaller than or equal to 9, a sequence in the tree 700 is from the first node 702A to the third node 702C. The first branch 706A accordingly represents the environmental setup 120.

Additionally, in the tree 700, the second and third branches 706B-706C as well as the second, third, fourth, fifth, third, sixth, and seventh nodes 702B-702G represent the FUA 118. Specifically, a second branch 706B from the second node 702B to the fourth node 702D or from the second node 702B to the fifth node 702E may be based on a value of a second variable “b.” Additionally, in the tree 700, a third branch 706C from the third node 702C to a sixth node 702F or from the third node 702C to a seventh node 702G may be based on the value of a second variable “b.” Specifically, if the value of “b” is greater than 0, a sequence in the tree 700 may be from the second node 702B to the fourth node 702D or from the third node 702C to the sixth node 702F. If the value of “b” is less than or equal to 0, a sequence in the tree 700 may be from the second node 702B to the fifth node 702E or from the third node 702C to the seventh node 702G.

Likewise, fourth and fifth branches 706D and 706E as well as the fourth, eighth, ninth, sixth, tenth, and eleventh nodes 702D, 702H, 7021, 702F, 702J, and 702K represent the called function 122. Specifically, the fourth and fifth branches 706D and 706E may depend on a value of a third variable “c.”

Evaluating the tree 700, the FUA 118 may be covered through execution of two paths 704. Specifically, in the tree 700, the FUA 118 may be covered by executing a third path 704C and one of the first path 704A, the second path 704B, a fourth path 704D, or a fifth path 704E. Alternatively, the FUA 118 may be covered by executing a sixth path 704F and one of the first path 704A, the second path 704B, the fourth path 704D, or the fifth path 704E.

With combined reference to FIGS. 3A, 3B, 6, and 7, an example analysis of the FUA 118 based on the tree 700 and the control flow graph 600 is described. Symbolic execution of the FUA 118 may begin by selecting the first node 702A (block 324). The first node 702A may not be covered (“No” at block 328). Accordingly, the first node 702A may be executed (block 330). Additionally, the first node 702A may be used to create an FUA path (block 304).

The FUA path based on the first node 702A may include a third basic block 602C. The first node 702A generates new coverage of the FUA 118 (“Yes” at block 306), specifically coverage of the third basic block 602C. Additionally, the first node 702A may be analyzed (block 334). The FUA path may include a single statement “return,” e.g., the third basic block 602C, which is selected (block 308). No uncovered fragment of the FUA 118 may be reachable from the third basic block 602C (“No” at block 310) and there may be no more FUA path statements (“No” at block 314). Accordingly, a set of covered FUA fragments may be updated to include the third basic block 602C (block 316). Only the third basic block 602C is covered, thus the FUA is not covered (“No” at block 318). The set of partial paths may be updated (block 320) to indicate the first node 702A has been executed. There are remaining partial paths (“No” at block 322), thus the second node 702B and/or the third node 702C may be selected (block 324).

The second node 702B may not be covered (“No” at block 328). The second node 702B may accordingly be executed (block 330). Additionally, the second node 702B may be used to create an FUA path (block 304). The FUA path created using the second node 702B may include the third basic block 602C similar to the FUA path created by the first node 702A. Accordingly, the FUA path created by the second node 702B covers the third basic block 602C, which is already covered. The FUA path does not generate new coverage for the FUA 118 (“No” at 306). The set of partial paths may be updated (block 320) to indicate that the second node 702B has been explored. Analyses of the third node 702C, the fourth node 702D, and the sixth node 702F are similar to the analysis of the second node 702B.

The eighth node 702H may then be selected (block 324). The eighth node 702H may be executed (block 330) and an FUA path may be created using the eighth node 702H (block 302). The FUA path created using the eighth node 702H may include the first basic block 602A, the second basic block 602B, and the third basic block 602C. The FUA path created using the eighth node 702H accordingly generates new coverage for the FUA 118, e.g., the second basic block 602B and partial coverage of the first basic block 602A may be new coverage (“Yes” at block 306). The third basic block 602C may be selected (block 308). The third basic block 602 may be an end of the FUA path. Accordingly, an uncovered fragment of the FUA 118 is not reachable from the third basic block 602C (“No” at block 310).

The second basic block 602B may then be selected (blocks 314 and 308). Because the third basic block 602C has already been covered, an uncovered fragment of the FUA 118 is not reachable from the second basic block 602B (“No” at block 310). The first basic block 602A may then be selected (blocks 314 and 308). Again, the second basic block 602B has been covered, but the fourth basic block 604D may not have been covered. Thus, an uncovered fragment of the FUA 118 is reachable from the first basic block 602A (“Yes” at block 310). The first basic block 602A may then be added to a set of covered statements (block 312).

The set of covered FUA fragments may be updated (block 316). Because the fourth basic block 602D is not covered and the first basic block 602A is only partially covered, the FUA is not covered (“No” at block 318). The set of partial paths may be updated (block 320). Additionally, no resource constraint exists and there are remaining partial paths (“No” in block 322), thus a ninth node 7021 may be selected (block 324).

The ninth node 7021 may not be covered (“No” at block 328). The ninth node 7021 may accordingly be executed (block 330). Additionally, the ninth node 7021 may be used to create an FUA path (block 304). The FUA path created using the ninth node 7021 may include the first basic block 602A, the second basic block 602B, and third basic block 602C similar to the FUA path created by the eighth node 702H. Accordingly, the FUA path created by the ninth node 7021 covers basic blocks 602, which are already covered. The FUA path does not generate new coverage for the FUA 118 (“No” at 306).

The set of partial paths may be updated (block 320). Additionally, no resource constraint exists and there are remaining partial paths (“No” in block 322), thus the fifth node 702E may be selected (block 324).

The fifth node 702E may then be selected (block 324). The fifth node 702E may be executed (block 330), and an FUA path may be created using the fifth node 702E. The FUA path created using the fifth node 702E may include the first basic block 602A, the fourth basic block 602D, and the third basic block 602C. The FUA path created using the fifth node 702E accordingly generates new coverage for the FUA 118 (“Yes” at block 310), e.g., the fourth basic block 602D and partial coverage of the first basic block 602A may be new coverage. The third basic block 602C may be selected (block 308). The third basic block 602C may be an end of the FUA path. Accordingly, an uncovered fragment of the FUA 118 is not reachable from the third basic block 602C (“No” at block 310).

The fourth basic block 602D may then be selected (blocks 314 and 308). Because the third basic block 602C has already been covered, an uncovered fragment of the FUA 118 is not reachable from the fourth basic block 602D (“No” at block 310). The first basic block 602A may then be selected (blocks 314 and 308). Again, the fourth basic block 602D has been covered and the second basic block 602B may have been already covered. Thus, an uncovered fragment of the FUA 118 is not reachable from the first basic block 602A.

The set of covered FUA fragments may be updated (block 316). Because the basic blocks 602 are covered, the FUA is covered (“Yes” at block 318). The symbolic execution may be stopped (block 332). Accordingly, the FUA 118 is covered and in the tree 700 analysis of included symbolic execution of the first, second, third, fourth, fifth, eighth, and ninth nodes 702A, 702B, 702C, 702D, 702E, 702H, and 702I.

The embodiments described herein may include the use of a special-purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may comprise non-transitory computer-readable storage media including RAM, ROM, EEPROM, CD-ROM or other optical disk storage, magnetic disk storage or other magnetic storage devices, or any other non-transitory storage medium which may be used to carry or store desired program code in the form of computer-executable instructions or data structures and which may be accessed by a general-purpose or special-purpose computer. Combinations of the above may also be included within the scope of computer-readable media.

Computer-executable instructions comprise, for example, instructions and data which cause a general-purpose computer, special-purpose computer, or special-purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method of software program verification, the method comprising:
receiving at least a portion of a software program, the received portion of the software program including a function under analysis (FUA);
creating an FUA path based at least partially on a path through one or more functions included in the received portion of the software program;
determining whether the FUA path generates new coverage for the FUA;
in response to the FUA path generating new coverage, selecting an FUA path statement from the FUA path;
determining whether an uncovered code fragment of the FUA is reachable from the selected FUA path statement based at least partially on a set of covered FUA code fragments; and
in response to the uncovered code fragment being reachable from the selected FUA path statement, adding the selected FUA path statement to a set of covered statements.

2. The method of claim 1, further comprising, in response to the FUA path not generating new coverage, updating a set of partial paths included in the received portion of the software program (set of partial paths).

3. The method of claim 1, further comprising:
determining whether the FUA path includes an additional FUA path statement;
in response to the FUA path including the additional FUA path statement, selecting the additional FUA path statement from the FUA path;
determining whether another uncovered fragment of the FUA is reachable from the selected additional FUA path statement; and
in response to the other uncovered fragment being reachable from the selected additional FUA path statement, adding the selected additional FUA path statement to the set of covered statements.

4. The method of claim 3, further comprising:
in response to the FUA path not including another FUA path statement, updating a set of covered FUA fragments;
determining whether the FUA is covered; and
in response to the FUA not being covered, updating the set of partial paths.

5. The method of claim 4, further comprising:
determining whether there is a resource constraint or there are no more paths in the received portion of the software program; and
in response to there being a resource constraint or there being no more paths, stopping a symbolic execution of the FUA.

6. The method of claim 5, further comprising, in response to there not being a resource constraint or there being remaining paths:
selecting another path remaining in the set of partial paths;
selecting a path statement included in the selected path;
determining whether the selected path statement is covered based at least partially on the set of covered statements;
in response to the selected path statement not being covered, symbolically executing the selected path statement; and
in response to the selected path statement being covered, using the selected path statement to create an FUA path.

7. The method of claim 1, further comprising:
determining whether the FUA path includes an additional FUA path statement; and
in response to the FUA path not including the additional FUA path statement:
updating a set of covered FUA fragments;
determining whether the FUA is covered; and
in response to the FUA being covered, stopping a symbolic execution of the FUA.

8. The method of claim 1, further comprising:
in response to the FUA not generating new coverage, determining whether the FUA path includes an additional FUA path statement;
in response to the FUA path including the additional FUA path statement, selecting the additional FUA path statement;
determining whether another uncovered fragment of the FUA is reachable from the selected additional FUA path statement; and
in response to the other uncovered fragment being reachable from the selected additional FUA path statement, adding the selected additional FUA path statement to the set of covered statements.

9. The method of claim 1, wherein coverage of the FUA is evaluated according to one or more of function coverage, statement coverage, branch coverage, path coverage, line coverage, decision coverage, condition coverage, state coverage, modified condition/decision coverage (MCDC), and parameter value coverage.

10. The method of claim 1, further comprising, in response to the FUA path generating new coverage, analyzing the FUA path to generate an FUA analysis report.

11. A non-transitory computer-readable medium having encoded therein programming code executable by a processor to perform operations comprising:
receiving at least a portion of a software program, the received portion of the software program including a function under analysis (FUA);
creating an FUA path based at least partially on a path through one or more functions included in the received portion of the software program;
determining whether the FUA path generates new coverage for the FUA;
in response to the FUA path generating new coverage, selecting an FUA path statement from the FUA path;
determining whether an uncovered code fragment of the FUA is reachable from the selected FUA path statement based at least partially on a set of covered FUA code fragments; and
in response to the uncovered code fragment being reachable from the selected FUA path statement, adding the selected FUA path statement to a set of covered statements.

12. The non-transitory computer-readable medium of claim 11, wherein the operations further comprise, in response to the FUA path not generating new coverage, updating a set of partial paths included in the received portion of the software program (set of partial paths).

13. The non-transitory computer-readable medium of claim 11, wherein the operations further comprise:
determining whether the FUA path includes an additional FUA path statement;
in response to the FUA path including the additional FUA path statement, selecting the additional FUA path statement from the FUA path;
determining whether another uncovered fragment of the FUA is reachable from the selected additional FUA path statement; and
in response to the other uncovered fragment being reachable from the selected additional FUA path statement, adding the selected additional FUA path statement to the set of covered statements.

14. The non-transitory computer-readable medium of claim 13, wherein the operations further comprise:
in response to the FUA path not including another FUA path statement, updating a set of covered FUA fragments;
determining whether the FUA is covered; and
in response to the FUA not being covered, updating the set of partial paths.

15. The non-transitory computer-readable medium of claim 14, wherein the operations further comprise:
determining whether there is a resource constraint or there are no more paths in the received portion of the software program; and
in response to there being a resource constraint or there being no more paths, stopping a symbolic execution of the FUA.

16. The non-transitory computer-readable medium of claim 15, wherein the operations further comprise, in response to there not being a resource constraint or there being remaining paths:
selecting another path remaining in the set of partial paths;
selecting a path statement included in the selected path;
determining whether the selected path statement is covered based at least partially on the set of covered statements;
in response to the selected path statement not being covered, symbolically executing the selected path statement; and
in response to the selected path statement being covered, using the selected path statement to create an FUA path.

17. The non-transitory computer-readable medium of claim 11, wherein the operations further comprise:
determining whether the FUA path includes an additional FUA path statement; and
in response to the FUA path not including the additional FUA path statement:
updating a set of covered FUA fragments;
determining whether the FUA is covered; and
in response to the FUA being covered, stopping a symbolic execution of the FUA.

18. The non-transitory computer-readable medium of claim 11, wherein the operations further comprise:
in response to the FUA not generating new coverage, determining whether the FUA path includes an additional FUA path statement;
in response to the FUA path including the additional FUA path statement, selecting the additional FUA path statement;
determining whether another uncovered fragment of the FUA is reachable from the selected additional FUA path statement; and
in response to the other uncovered fragment being reachable from the selected additional FUA path statement, adding the selected additional FUA path statement to the set of covered statements.

19. The non-transitory computer-readable medium of claim 11, wherein coverage of the FUA is evaluated according to one or more of function coverage, statement coverage, branch coverage, path coverage, line coverage, decision coverage, condition coverage, state coverage, modified condition/decision coverage (MCDC), and parameter value coverage.

20. The non-transitory computer-readable medium of claim 11, wherein the operations further comprise, in response to the FUA path generating new coverage, analyzing the FUA path to generate an FUA analysis report.
